(19) United States
(12) Patent Application Publication
(10) Pub. No.: US 2009/0004639 A1
(43) Pub. Date: Jan. 1, 2009

(54) INTERACTIVE TEACHING AID

(75) Inventors: Tammy Elizabeth Stout, Murfreesboro, TN (US); Tres Bancell Holmes, Murfreesboro, TN (US); Michael McGee, Tullahoma, TN (US)

Correspondence Address: HARNESS, DICKEY & PIERCE, P.L.C., P.O. BOX 828, BLOOMFIELD HILLS, MI, 48303, US

(73) Assignee: DreamSmart With Mat & Mattie, L.L.C., Murfreesboro, TN (US)

(21) Appl. No.: 12/146,151

(22) Filed: Jun. 25, 2008

Related U.S. Application Data
(60) Provisional application No. 60/946,689, filed on Jun. 27, 2007.

(51) Int. Cl. G09B 25/00

(52) U.S. Cl. 434/365

(57) ABSTRACT

A teaching aid is provided. The teaching aid can include a first portion. The first portion can include at least one shape, at least one fine motor skill activity and at least one alphabet. The teaching aid can also include a second portion. The second portion can include a numeric scale, at least one self esteem activity, at least one safety activity and at least one large motor skill activity. The first portion can be coupled to the second portion to form an aid to teach early childhood development skills for preschool.

### CROSS-REFERENCE TO RELATED APPLICATIONS

This application claims the benefit of U.S. Provisional Application No. 60/946,689, filed on Jun. 27, 2007. The disclosure of the above application is incorporated herein by reference.

### FIELD

The present disclosure relates generally to teaching aids, and more specifically, to an interactive learning tool or teaching aid for teaching early childhood skills.

### BACKGROUND

The statements in this section merely provide background information related to the present disclosure and may not constitute prior art.

Parents generally look to instructional devices and teaching aids to ready their young children for school. Many instructional devices exist, such as talking books, video games and toys, which can teach the child one or two skills through the child's interaction with the device. For instance, the child can manipulate a joystick to learn letters while developing fine motor skills.

These interactive devices, however, do not generally promote family togetherness, or family interaction. Further, these interactive devices typically do not teach all of the skills required for school readiness, and thus, the parent or instructor must invest in a variety of different interactive devices to fully prepare the child for school. Accordingly, it may be desirable to provide a teaching aid that facilitates learning most of the skills necessary for school readiness on a single device, while also promoting family interaction with the child.

### SUMMARY

A teaching aid is provided. The teaching aid can include a first portion. The first portion can include at least one shape, at least one fine motor skill activity and at least one alphabet. The teaching aid can also include a second portion. The second portion can include a numeric scale, at least one self esteem activity, at least one safety activity and at least one large motor skill activity. The first portion can be coupled to the second portion to form an aid to teach early childhood development skills for preschool.

Further provided is a teaching aid that includes a housing. The housing can include at least three sections and a child-like character. One of the at least three sections can have a first color, one of the at least three sections can have a second color, and the other of the at least three sections can have a third color. The first color, the second color and the third color can be different primary colors. The child-like character can have a plurality of labeled body parts and clothing, which can include at least one fine motor skill activity. The teaching aid can also include a support structure, which can be disposed within the housing to enable comfortable use of the teaching aid.

Further provided is a teaching aid. The teaching aid can include a first cover. The first cover can be divided into quadrants, and can include a character, with at least a portion of the character in each of the quadrants. Each quadrants can have a unique color, and at least one the quadrants can include a plurality of unique shapes. At least one of the quadrants can include at least one fine motor skill activity. The character can have a plurality of body parts, and at least one of the plurality of body parts can be identified. The teaching aid can also include a second cover. The second cover can be divided into quadrants, and can include a numeric scale. The numeric scale can extend down a longitudinal axis of the second cover. Each of the quadrants can have a unique color from the quadrants of the first cover. At least one of the quadrants can include at least one self esteem activity, at least one of the quadrants can include at least one large motor skill activity, and at least one of the quadrants can include at least one safety activity. The second cover can be coupled to the first cover to define a housing. The teaching aid can also include a support structure, which can be disposed within the housing to facilitate the use of the first cover, second cover and combinations thereof.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1A is a schematic illustration of an interactive learning mat or teaching aid according to various embodiments of the present disclosure in a first configuration;

FIG. 1B is a schematic illustration of the teaching aid of FIG. 1A according to various embodiments of the present disclosure in a second configuration; and

FIG. 2 is a schematic illustration of a second portion of the teaching aid of FIGS. 1A and 1B.

### DETAILED DESCRIPTION

The following description is merely exemplary in nature and is not intended to limit the present disclosure, application, or uses. It should be understood that throughout the drawings, corresponding reference numerals indicate like or corresponding parts and features. As indicated above, the present teachings are directed toward providing an interactive learning mat, which can include an instructional guide. It should be noted, however, that the present teachings could be applicable to any appropriate procedure in which it is desirable to learn about various subjects through play and interaction. Therefore, it will be understood that the following discussions are not intended to limit the scope of the appended claims.

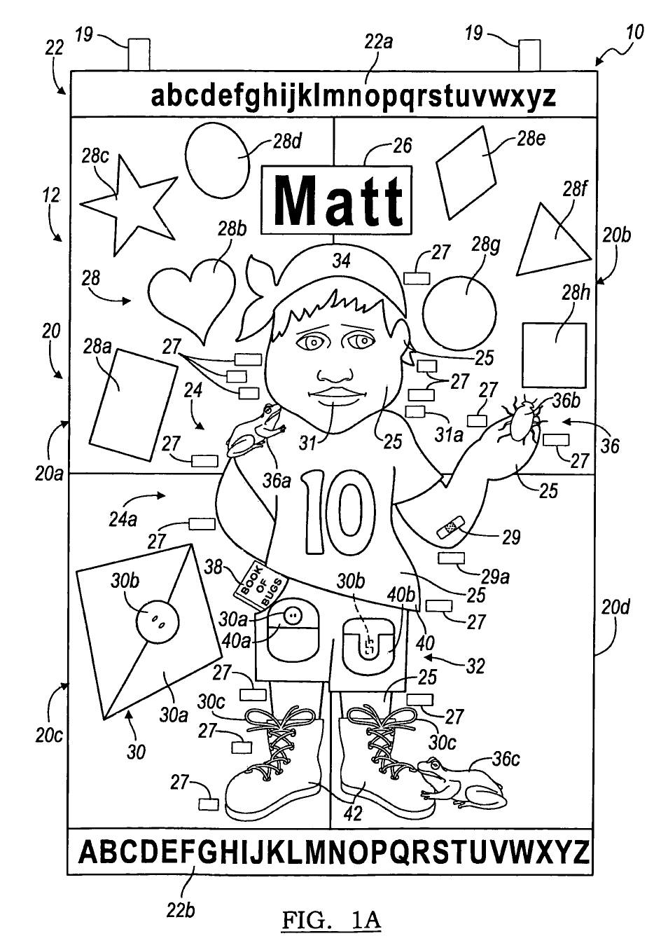

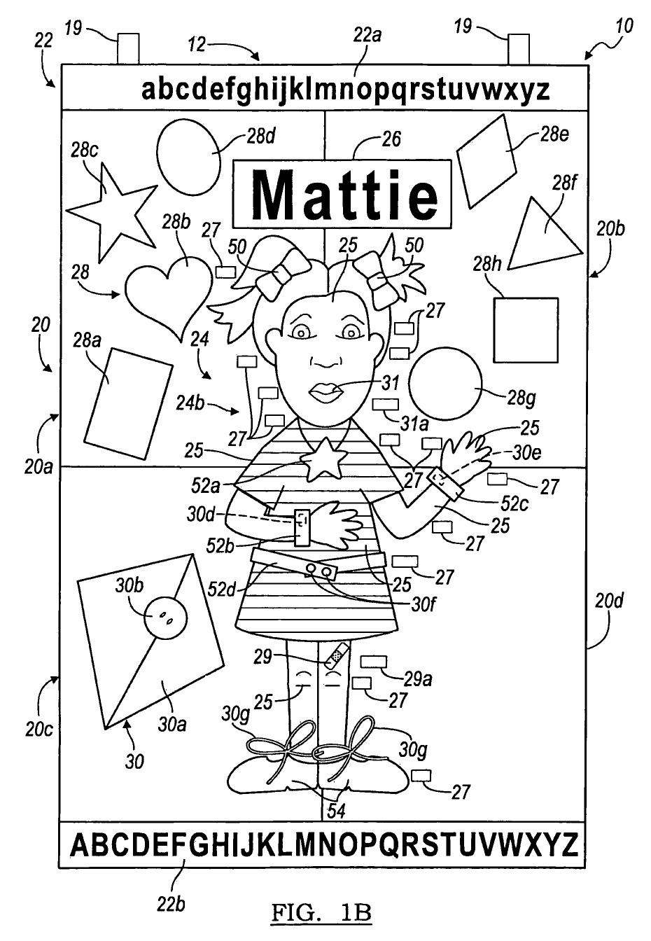

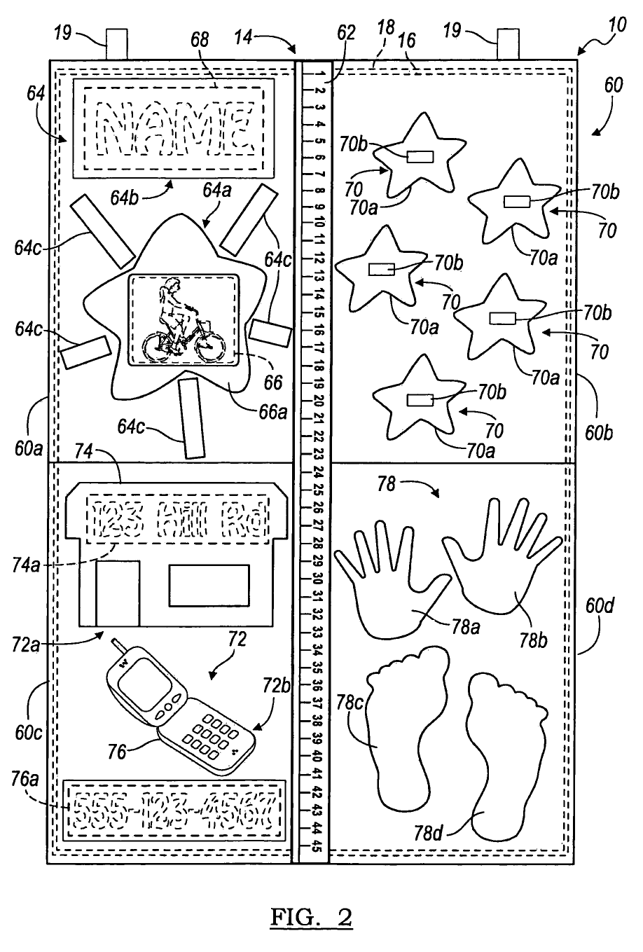

With reference to FIGS. 1A-2, an exemplary interactive learning mat or teaching aid 10 is shown. The teaching aid 10 can include a first portion or cover 12, a second portion or cover 14, a support structure 16 (FIG. 2), and optionally, an instructional guide. The first cover 12 can have two configurations (FIG. 1A and FIG. 1B), as will be discussed, while the second cover 14 can generally have a single configuration (FIG. 2). The first cover 12 can be coupled to the second cover 14 to define a housing 18 that can receive the support structure 16. It should be noted, however, that the support structure 16 can be optional, and further, the first cover 12 could be coupled to the second cover 14 in any desirable position. For example, the first cover 12 and the second cover 14 could be coupled along a longitudinal edge to form a large sheet, poster, placard, etc. The first cover 12 and the second cover 14 can be coupled together through any suitable technique, such as sewing, bonding, mechanical fasteners, buttons, zippers, etc. or could be integrally formed.

The first cover 12 and the second cover 14 can cooperate with the optional instructional guide to teach a plurality of early childhood development skills for preschool, such as shapes, numbers, alphabet, fine motor skills, large motor skills, self-esteem, social skills, safety skills, colors, body parts, etc. It should be understood that although the teaching aid 10 is described and illustrated herein as for teaching early development skills for preschool, the teaching aid 10 could be configured to teach a variety of other skills, such as health and fitness skills. The first cover 12 and the second cover 14 can be composed of a fabric-like material, such as a washable or dry clean only fabric, for example, cotton, nylon, polyester, or combinations thereof. In addition, it should be noted that the first cover 12 and second cover 14 can be composed of any desired material, and can be made of a polymeric or poster material, if desired, to facilitate the posting of the first cover 12 and the second cover 14 in a classroom, for example. Further, the first cover 12 and the second cover 14 can include at least one hanging feature 19, such as loops, rings, tabs, etc., which can facilitate the hanging of the teaching aid 10. In addition, the hanging feature 19 can be configured to enable the teaching aid 10 to be secured in a compact storage position, for example, the loops could be configured to wrap around the teaching aid 10 when the teaching aid 10 is rolled, similar to a sleeping bag.

With reference to FIGS. 1A and 1B, the first cover 12 can include a plurality of sections 20, at least one alphabet 22, a character 24 and a character name 26. The plurality of sections 20 can each have a specific unique color. For example, the sections 20 can be divided into quadrants 20a-20d, and each of the quadrants 20a-20d can have a unique color, such as primary color or a secondary color. For example, the quadrant 20a can be a primary color, such as yellow, the quadrant 20b can be a primary color, such as red, the quadrant 20c can be a secondary color, such as green, and the quadrant 20d can be a primary color, such as blue. Thus, the sections 20 can be used to teach colors, as will be discussed in greater detail herein.

Each of the sections 20 can also be used to teach other skills. For example, the quadrant 20a and the quadrant 20b can each include at least one shape 28. The at least one shape 28 can comprise any suitable geometric shape, which can optionally be in a contrasting color, and optionally, can be formed of a contrasting material than the first cover 12. Generally, the quadrant 20a can include four geometric shapes 28a-d, and the quadrant 20b can include four geometric shapes 28e-h. For example, shape 28a can be a rectangle, shape 28b can be a heart, shape 28c can be a star, shape 28d can be an oval, shape 28e can be a diamond, shape 28f can be a triangle, shape 28g can be a circle and shape 28h can be a square. Each of the shapes 28a-h can be in the same or in a different color. The shapes 28a-h can also each be composed of a different, distinct material to facilitate kinesthetic learning, such as corduroy, terry cloth, felt, velvet, silk, velour, etc., and can be raised from the first cover 12, or optionally, can include raised features, such as bumps.

Thus, the quadrants 20a, 20b, along with the shapes 28a-h, can be used to teach shapes. For example, the child can find the circle or shape 28g on the first cover 12. The child can place a dried cereal around the outer edge of the circle or shape 28g and can also feel the texture and shape of the circle 28g. In another example, using different shaped objects such as those found in the child's environment, the child can be instructed to place similar shaped objects on or adjacent to the shape 28 on the teaching aid 10 that corresponds with that object. In another example, an instructor can point to a shape 28 on the first cover 12 and can ask the child to name the shape 28. Then, the child can be asked to find objects in his environment that are the same shape. In another example, an instructor can pick a shape 28 from the first cover 12 and can ask the child to find large pictures in a magazine that are the same shape. Then, the child can cut the pictures out and can place the pictures on the matching shape 28 on the first cover 12. This can also help the child develop fine motor skills.

The quadrant 20c can include a fine motor skill activity 30. For example, the fine motor skill activity 30 can include a pocket 30a with a button 30b. By manipulating the button 30b to unbutton and button the pocket 30a, the user or child can learn, develop or improve fine motor skills.

The at least one alphabet 22 can comprise a first, lower case alphabet 22a and a second, upper case alphabet 22b. It should be noted that although the alphabet 22 is illustrated herein as being an English alphabet, it should be noted that the alphabet could be any desired alphabet, such as Spanish, French, Japanese, etc. The first alphabet 22a can be positioned near a top edge of the first cover 12, while the second alphabet 22b can be positioned near a bottom edge of the first cover 12. It will be understood, however, that the alphabet 22a, 22b could be positioned at any desired location on the first cover 12, and optionally, could be positioned on the second cover 14. Each of the first alphabet 22a and the second alphabet 22b can include consonants in a first color, and vowels in a second color, with each of the first color and the second color being distinct and contrasting with the colors of the sections 20 adjacent to the respective first and second alphabet 22a, 22b. Alternatively, the consonants could have a different texture than the vowels, for example, to facilitate kinesthetic learning. Generally, the first and second alphabet 22a, 22b can be in a font that is similar to the writing style of a preschool age child, such as ABC Print or Kidsprint, which are both commercially available.

The first and second alphabet 22a, 22b can each be used to teach letters. For example, an instructor can write upper case letters on individual index cards and the child can be instructed to find the same letter on the second alphabet 22b. The child can also be instructed to name that letter and its sound and to think of a word or words that have that letter sound. The child can also be instructed to locate objects that begin with that sound. In another example, the child can pick the letter on the alphabet 22 with which his name begins. Then, the child can find that letter in a magazine or newspaper and cut it out and place that letter on the teaching aid 10. In one example, the instructor can write the child's name on a sentence strip. Then, the instructor can have the child use their fingers to trace the letters of the name, and the child can be instructed to write the name correctly. The child can also look for letters in their name using the alphabet 22. In one example, a pointer can be used with the teaching aid 10 to identify an upper case letter on the second alphabet 22b and the matching lower case letter on the first alphabet 22a. The child can also be instructed to say the letters when the pointer contacts them. In one example, the child can point to the first letter of their name on the alphabet 22 and the instructor can instruct the child to form the letter with cereal or another object. In one example, using a bag full of objects from the environment or toys, the child can pull an object out of the bag and can be instructed to point to the letter on the alphabet 22 that corresponds with the beginning sound of that object.

The character 24 can be positioned on the first cover 12 such that at least a portion of the character 24 is disposed within each of the quadrants 20a-d. The character 24 can generally be a human child-like character, and can be child sized, such as the size of a child of preschool age. The character 24 can include at least one or a plurality of body parts 25, which can include labels 27. The labels 27 can identify the associated body part 25. It should be noted that although the labels 27 are shown herein as being in English, the labels 27 could be in any language, and could be provided in multiple languages as part of a kit for use with the teaching aid 10.

The body parts 25 can teach the child about his/her body. For example, the child can be instructed to point to the mouth on the character 24 and then point to his or her mouth. This can be repeated for each of the five senses (ear, nose, eyes, hands for touching). The child can then be instructed to describe the different things that he can do with each of his five senses. In one example, the instructor can call out one of the body parts 25 on the first cover 12. Then, the child can use a pointer to identify that body part 25. In one example, the instructor can review all of the body parts 25 with the child and can explain how to keep these body parts 25 healthy. In this regard, the child can be shown a variety of health items such as soap, toothpaste, toothbrushes, hair brushes, health food, etc. and can be instructed how to keep herself or himself healthy using these objects. In one example, a pointer can be used to point to one of the body parts 25 on the first cover 12 and then the instructor or the child can say the name of that body part 25 identified in the label 27. Then, the child can be instructed to point to the letter on the alphabet 22 that corresponds to the sound of that body part 25.

With reference to FIGS. 1A and 1B, generally, the skin color of the character 24 can be a non-racial color, such as green, however, the skin color of the character 24 could be similar to that associated with a particular race, if desired. The character 24 can also include a bandage 29, which can be coupled to the skin of the character 24. It should be noted that the bandage 29 can be removably coupled to the skin of the character 24, or could be integrally formed with the skin of the character 24, such as through printing, for example. The bandage 29 can also include a suitable label 29a, such as “Oops.”

The character 24 can have a facial expression, such as a smile 31, which can be labeled by a label 31a. Although the character 24 is illustrated herein as smiling, it should be noted that the character 24 could have any desirable facial expression, and further, the teaching aid 10 could include a kit that has a variety of different facial expressions such that the user or child could vary the facial expressions with the mood or emotional state of the child. Further, the character 24 can be gender specific, and can have at least one fine motor skill activity 32. As the teaching aid 10 is gender specific, the teaching aid 10 could also be provided with a kit that includes gender specific clothing and/or accessories to teach the child what type of clothing goes on which body part 25, in addition to what type of clothing is appropriate in particular social situations (e.g. party dress, school uniform, etc.), weather conditions (e.g. winter hat, gloves, swim suit, sunscreen, etc.).

For example, with reference to FIG. 1A, a male character 24a is illustrated. The male character 24a can include a head covering 34, at least one animal 36, a book 38, clothing 40 and shoes 42. The head covering 34 can be positioned on the head of the male character 24a. It should be noted, that although a bandana is illustrated herein, the male character 24a could have any suitable head dress or head covering, or could have no head covering. In addition, a kit could be provided with multiple head coverings to enable the personalization of the male character 24a, or to enable the user or child to learn about various cultures.

The at least one animal 36 can be positioned on or held by the male character 24a. For example, the at least one animal 36 could comprise one or more animals 36, such as a frog 36a, a bug 36b and a toad 36c. The frog 36a can be positioned on a shoulder of the male character 24a, and the bug 36b can be held by a hand of the male character 24a. The toad 36c can be positioned on a portion of one of the shoes 42. The book 38 can relate to the at least one animal 36, and in this example, can comprise a book about bugs. The at least one animal 36 and the book 38 can be used to help identify words that rhyme. For example, an instructor can have the child point to the bug 36b, and can instruct the child to think of all the words that rhyme with “bug.” This can be repeated with the frog 36a, toad 36c and book 38, for example.

The at least one fine motor skill activity 30 can be provided on the clothing 40 and shoes 42 of the male character 24a. For example, the clothing 40 can include a first pocket 40a with a first fine motor skill activity 30a and a second pocket 40b with a second fine motor skill activity 30b. In this regard, the first pocket 40a can include a snap, which can be snapped and unsnapped to open and close the first pocket 40a, while the second pocket 40a can include a hook and loop-type fastener, such as VELCRO™, which can be pulled and pushed to open and close the second pocket 40b. Thus, both the snap and the hook and loop-type fastener can comprise fine motor skill activities 30, which can teach or develop fine motor skills.

The shoes 42 can also include the at least one fine motor skill activity 30. For example, the shoes 42 can include laces, which can comprise a third fine motor skill activity 30c. The laces can be tied or untied to teach or develop fine motor skills. It will be understood, however, that the shoes 42, could also include a hook and loop-type fastener, if desired or in addition to the laces.

With reference to FIG. 2A, a female character 24b is illustrated. The female character 24b can include a head covering 50, at least one personal accessory 52 and shoes 54. The head covering 50 can be positioned on the head of the female character 24b. It should be noted, that although one or more bows are illustrated herein, the female character 24b could have any suitable head dress or head covering, or could have no head covering. In addition, a kit could be provided with multiple head coverings to enable the personalization of the female character 24b, or to enable the user or child to learn about various cultures.

The at least one personal accessory 52 can be used to teach fine motor skills, and thus, the at least one personal accessory 52 can comprise the at least one fine motor skill 30 for the female character 24b. For example, the at least one personal accessory 52 can include a necklace 52a, a first bracelet 52b, a second bracelet 52c and a belt 52d. The first bracelet 52b can include a hook and loop-type fastener, which can comprise a first fine motor skill activity 30d associated with the female character 24b. The second bracelet 52c can also include a hook and loop-type fastener, which can comprise a second fine motor skill activity 30e. The belt 52d can include at least one snap, which can comprise a third fine motor skill activity 30f associated with the female character 24b.

The shoes 54 can also include the at least one fine motor skill activity 30. For example, the shoes 54 can include ribbons, which can comprise a fourth fine motor skill activity 30g. The ribbons can be tied or untied to teach or develop fine motor skills. It will be understood, however, that the shoes 54, could also include a hook and loop-type fastener, if desired or in addition to the ribbons.

The character name 26 can correspond with the gender of the character 24. For example, the name of the male character 24a can be “Matt.” The name for the female character 24b can be “Mattie.” The character name 26 can be in a large, easy to read font, and can be positioned such that at least a portion of the character name 26 is within the first quadrant 20a and the second quadrant 20b. It should be noted, however, that the character name 26 can be in any desired location, and optionally, can be personalized by the user. Further, it should be noted that although the character name 26 is shown in English, the character name 26 could be in any language.

With reference to FIG. 2, the second cover 14 can include a plurality of sections 60 and a numeric scale 62. The plurality of sections 60 can each have a specific unique color, which can be distinct from the colors of the sections 20 of the first cover 12. For example, the sections 60 can be divided into quadrants 60a-d, and each of the quadrants 60a-d can have a unique color, such as primary color or a secondary color. For example, the quadrant 60a can be composed of all the primary colors, and can be black. The quadrant 60b can be a secondary color, such as purple, the quadrant 60c can be a secondary color, such as brown, and the quadrant 20d can be a secondary color, such as orange.

Thus, the section 60 of the second cover 14 and the section 20 of the first cover 12 can be used to teach colors. For example, an instructor can gather toys of various colors and place them in a large bag. Then, the instructor can instruct the child to pick a toy out of the bag and place the toy on a section of the mat that is the same color. In one example, an instructor can point to one of the quadrants 20a-d or 60a-d and can ask the child to find various toys and/or objects from their surrounding environment that are of the same color as the selected quadrants 20a-d, 60a-d. Further, the child can count all of the objects of the same color that were found, and can point to the corresponding number on the numeric scale 62. In one example, a child can toss a sock onto the mat and the instructor can ask the child the color of corresponding section 20, 60 that the sock is on. In another example, the instructor can pick a color from the sections 20, 60 and can have the child find pictures in a magazine that correspond to the color of the section 20, 60. Then, the child can then cut those pictures out and place the pictures on the matching color section 20, 60. The child can also count all of the pictures associated with the color section 20, 60, and can point to that number on the numeric scale 62. In addition, the teaching aid 10 can also teach colors by instructing a child to pick a favorite color from the teaching aid 10. Then, the instructor and the child can wear clothing of that color for the day. In addition, the child can be asked to describe the colors of the sections 20, 60 in complete sentences.

In addition, each of the sections 60 can be used to teach other skills. For example, the quadrant 60a can include at least one self-esteem activity 64. The self-esteem activity 64 can include a photo frame 64a, a name frame 64b, and at least one self-esteem phrase 64c. The photo frame 64a can be positioned in a center of the quadrant 60a, and can comprise a clear pocket 66. The clear pocket 66 can be composed of a polymeric material, and can be coupled to the second cover 14 to define a slot for receipt of a photo of the user or child. A star 66a can also be centered behind the pocket 66, if desired. The name frame 64b can also include a clear pocket 68, which can be composed of a polymeric material. The clear pocket 68 can be coupled to the second cover 14 to enable the receipt of a name of the user or child. The photo frame 64a and the name frame 64b can teach the child self-esteem and self-confidence. For example, the child can be asked to pick out a favorite photo, which can be placed in the photo frame 64a. In addition, the child's name can be placed on a sentence strip, which can be inserted into the clear pocket 68. The child can also practice writing his/her name on a sentence strip, which can be placed in the clear pocket 68. In one example, the child can look at the name in the name frame 64b and say it, and then can be instructed to go around to his environment and locate objects that begin with the same sound as his name.

The at least one self-esteem phrase 64c can be positioned about the star 66a of the photo frame 64a. The at least one self-esteem phrase 64c can be fixedly coupled to the second cover 14, or could be removable and replaceable with other phrases, or similar phrases in different languages. In one example, the at least one self-esteem phrase 64c can comprise a plurality of self-esteem phrases 64c, with phrases such as “I am _ years old,” “I am good at . . . ,” “I like . . . ,” “I am special because . . . ,” “My birthday is . . . ,” etc. The child can gain self-esteem from answering these phrases 64c, and other family members, instructors, or classmates can also discuss why the child is special, etc.

The quadrant 60b can teach social skills, and can include one or more manners or social skill activities 70. The social skill activities 70 can each include a shape, such as a star 70a, which can include a phrase 70b. The phrase 70b can emphasize good manners, and can include sayings such as “Please,” “You're Welcome,” “I'm Sorry,” “Thank you,” “Excuse Me,” etc. Thus, the social skill activities 70 can be used to teach good manners. For example, the child can be instructed to use the phrase(s) 70b throughout a day, and can be rewarded, for example with a sticker on the star 70a, every time the child uses these phrase(s) 70b.

The quadrant 60c can teach safety skills, and can include one or more safety skill activities 72. The safety skill activities 72 can include an address activity 72a and a phone number activity 72b. The address activity 72a can include a house 74. The house 74 can include a pocket 74a, such as a clear, polymeric pocket, for receipt of the address of the user or child. The phone number activity 72b can include a phone 76. The phone 76 can include a pocket 76a, such as a clear, polymeric pocket, receipt of the phone number of the user or child. The safety skill activities 72 can teach the child necessary personal information. For example, the child's phone number can be written on a sentence strip and placed in the pocket 76a, and the child can be instructed to pretend dialing the number on the phone 76.

The quadrant 60d can teach or develop large motor skills, and thus, can include one or more large motor skill activities 78. For example, the quadrant 60d can include a left handprint 78a, a right handprint 78b, a left footprint 78c and a right footprint 78d. Each of the left handprint 78a, a right handprint 78b, a left footprint 78c and a right footprint 78d can be used to teach or develop large motor skills. For example, the child can be instructed to stand on the left footprint 78c and the right footprint 78d. Then, the instructor can point to a number on the numeric scale 62 and can instruct the child to stomp in place that many times. In one example, the child can be instructed to place his/her hands and feet on top of the left handprint 78a, right handprint 78b, left footprint 78c, and right footprint 78d. Then, the child can be instructed to lift or raise at least one of his left hand, right hand, left foot or right foot off of the second cover 14.

The numeric scale 62 can pass through a center of the second cover 14, and can extend along a longitudinal axis of the second cover 14. The numeric scale 62 can comprise a metric or English scale, which can be used to teach numbers and math skills. The numeric scale 62 can be in any desired contrasting color, but generally, can be illustrated similar to a ruler or measuring tape.

The numeric scale 62 can teach numbers and math skills. For example, using a group of toys such as cars, blocks or stuffed animals, the child can count the toys and point to the number on the numeric scale 62 that corresponds with the number of toys. In another example, using a group of toys or objects, the child can be instructed to line the toys or objects up at an edge of the second cover 14 and use the numeric scale 62 to measure how long the toys or objects are. In another example, using a favorite food such as cereal, gold fish, or animal crackers, the child can divide the food into two groups and can then count the amount of the food in each group. Then, the child can point to the number on the numeric scale 62 that corresponds to that number of items in the group. In addition, the numeric scale 62 can be used to develop large motor skills. In this regard, the child can be instructed to walk heel-to-toe, to tiptoe, walk backwards, etc. following the numeric scale 62.

With continued reference to FIG. 2, the support structure 16 is illustrated in phantom. The support structure 16 can support the first cover 12 and the second cover 14, and can be retained within the housing 18 by one or more fasteners which can be coupled to an interior of the first cover 12 and second cover 14, such as hook and loop-type fasteners, buttons, snaps, etc. The support structure 16 can also serve as a cushion, which can provide an enjoyable surface for the user or child during the use of the teaching aid 10. The support structure 16 could comprise any material capable of forming a soft inner core between the first cover 12 and the second cover 14, such as a foam mat, feathers, stuffing, batting, etc.

The instructional guide, if included, can cooperate with the first cover 12 and the second cover 14 to teach parents, teachers, etc. how to use the first cover 12 and second cover 14. The instructional guide can include detailed examples of various lessons that can be taught using the teaching aid 10. In this regard, the instructional guide can include various interactive lessons or games directed towards various skills, such as identifying colors, identifying shapes, identifying numbers, math skills, large and fine motor skills, identifying letter and sounds, identifying body parts, etc. In addition, the instructional guide can include information on how to use the teaching aid 10 for recreational purposes, such as through reading, telling stories, etc. The instructional guide can also include one or more lists of skills that child should be able to perform independently in order to prepare the child for attending school, such as whether the child can dress his/her self, wash his/her hands, brush his/her hair, take turns, share toys, go to the bathroom alone, do chores, tie shoes, follow directions, etc.

Thus, the teaching aid 10 can teach early development skills needed by children for preschool, such as colors, shapes, numbers, letters, fine motor skills, large motor skills, safety skills, and social skills. In addition, the teaching aid 10, if provided with the instructional guide, can provide instructors or parents with various tools to enable their child to learn these skills in a fun, safe manner. In addition, as the teaching aid 10 can be personalized and life-like, the teaching aid 10 can become a “buddy” or toy for the child, thereby making learning a joyous experience.

While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out this disclosure, but that the scope of the present disclosure will include any embodiments falling within the foregoing description and the appended claims.

What is claimed is:

1. A teaching aid comprising:
a first portion that includes at least one shape, at least one fine motor skill activity and at least one alphabet;
a second portion that includes a numeric scale, at least one self esteem activity, at least one safety activity and at least one large motor skill activity; and
wherein the first portion is coupled to the second portion to form an aid to teach early childhood development skills for preschool.

2. The teaching aid of claim 1, wherein the first portion is divided into quadrants that each have a unique color selected from the group comprising: a primary color or a secondary color.

3. The teaching aid of claim 2, wherein the first portion further comprises:
a character, with at least a portion of the character in each of the quadrants, the character having a plurality of labeled body parts, clothing and shoes, with the clothing and shoes including at least one fine motor skill activity.

4. The teaching aid of claim 3, wherein the at least one alphabet comprises an uppercase alphabet and a lowercase alphabet, with the uppercase alphabet disposed in two of the quadrants, and the lowercase alphabet disposed in a different two of the quadrants.

5. The teaching aid of claim 4, wherein vowels in the uppercase alphabet and lowercase alphabet have a color different from consonants in the uppercase alphabet and lowercase alphabet.

6. The teaching aid of claim 5, wherein the at least one shape comprises a plurality of shapes, which are disposed in two of the quadrants, the plurality of shapes selected from the group comprising: a rectangle, a square, an oval, a circle, a triangle, a diamond, a heart and a star.

7. The teaching aid of claim 6, wherein at least one of the quadrants includes a fine motor skill activity.

8. The teaching aid of claim 7, wherein the at least one self-esteem activity comprises a photograph, a name, at least one self-esteem phrase, or combinations thereof.

9. The teaching aid of claim 8, wherein the second portion further comprises a social skill activity that teaches the use of good manners.

10. The teaching aid of claim 9, wherein the at least one safety activity further comprises a phone activity and an address activity to teach a telephone number and an address.

11. The teaching aid of claim 10, wherein the at least one large motor skill activity includes at least one handprint and at least one footprint that are coupled to the second portion.

12. The teaching aid of claim 11, wherein the first portion is coupled to the second portion to define a housing for receipt of a support structure.

13. A teaching aid comprising:
a housing that includes at least three sections and a child-like character, with one of the at least three sections having a first color, one of the at least three sections having a second color and the other of the at least three sections having a third color, the first color, the second color and the third color being different primary colors, the child-like character having a plurality of labeled body parts and clothing that includes at least one fine motor skill activity; and
a support structure disposed within the housing to enable comfortable use of the teaching aid.

14. The teaching aid of claim 13, wherein the child-like character is a male or a female.

15. The teaching aid of claim 14, wherein the at least one fine motor skill activity includes manipulating a snap, a hook and loop-type fastener, or combinations thereof.

16. The teaching aid of claim 15, wherein the housing further comprises a first portion and a second portion, the first portion including the at least three sections and the character, the second portion including at least three sections each having a unique color selected from the group of secondary colors, and a numeric scale.

17. The teaching aid of claim 16, wherein the support structure is received between the first portion and the second portion, and is a foam mat.

18. A teaching aid comprising:
a first cover that is divided into quadrants and includes a character, with at least a portion of the character in each of the quadrants and each quadrants having a unique color, at least one the quadrants including a plurality of unique shapes, at least one of the quadrants including at least one fine motor skill activity, and the character having a plurality of body parts, with at least one of the plurality of body parts identified;
a second cover that is divided into quadrants and includes a numeric scale, with the numeric scale extending down a longitudinal axis of the second cover, and each of the quadrants having a unique color from the quadrants of the first cover, at least one of the quadrants including at least one self esteem activity, at least one of the quadrants including at least one large motor skill activity, and at least one of the quadrants including at least one safety activity, the second cover coupled to the first cover to define a housing; and
a support structure disposed within the housing that facilitates the use of the first cover, second cover and combinations thereof.

19. The teaching aid of claim 18, wherein the support structure is a foam mat.

20. The teaching aid of claim 19, wherein the character is child-like and is male or female.
